(19) United States
(12) Patent Application Publication
(10) Pub. No.: US 2025/0378992 A1
(43) Pub. Date: Dec. 11, 2025

(54) FLAT COIL-TYPE WIRELESS CHARGING MODULE AND FLAT COIL-TYPE POWER SUPPLY

(71) Applicant: JISUNG ELECTRONICS, Incheon (KR)

(72) Inventor: Hwang-Sun YANG, Incheon (KR)

(21) Appl. No.: 19/079,742

(22) Filed: Mar. 14, 2025

(30) Foreign Application Priority Data
Mar. 15, 2024 (KR) 10-2024-0036413
Dec. 30, 2024 (KR) 10-2024-0201430

(51) Int. Cl. H01F 38/14; H01F 27/06; H01F 27/28; H01F 27/29; H01F 27/32

(52) U.S. Cl. CPC H01F 38/14; H01F 27/06; H01F 27/2871; H01F 27/29; H01F 27/323

(57) ABSTRACT

A flat coil-type wireless charging module and power supply where the module includes flat coils as laminated structures of one or more plastic sheets having a conductive pattern configured to form a magnetic circuit and formed in a C shape or a spiral shape having a predetermined width such that electrodes are connected to both ends thereof. The flat coil-type power supply has a configuration in which a conductive pattern is formed in a C shape or a spiral shape with a predetermined width on the upper surface of each of flat coils including one or more plastic sheets to form a magnetic circuit used for magnetic induction or resonance induction, electrodes are connected to both ends thereof, and a core space of a predetermined area are formed through the center of the conductive pattern so that a core is mounted therein.

### BACKGROUND

The present invention relates to a flat coil-type wireless charging module that is used as a wireless charger, and includes flat coils as laminated structures of one or more plastic sheets having a conductive pattern configured to form a magnetic circuit and formed in a C shape or a spiral shape having a predetermined width such that electrodes are respectively connected to both ends thereof. In addition, the present invention relates to a flat coil-type power supply used as a transformer and having a configuration in which a conductive pattern is formed on the upper surface of each of flat coils including one or more plastic sheets to form a magnetic circuit used for magnetic induction or resonance induction, the conductive pattern is formed in a C shape or a spiral shape with a predetermined width, electrodes are respectively connected to both ends thereof, and a core space of a predetermined area are formed through the center of the conductive pattern so that a core is mounted therein.

In general, wireless charging technology enables charging of various electric and electronic devices equipped with batteries, without connection of a power cable, using a power transmission system that converts electrical energy into electromagnetic waves that are wirelessly transmittable.

In addition, wireless charging methods may be broadly divided into an electromagnetic inductive coupling method, a short-range transmission (electromagnetic radiation) method, a magnetic resonance coupling method, and a microwave method.

Thereamong, based on the principle of wireless charging by the electromagnetic inductive coupling method, when a power supply is connected to a charging pad, an electromagnetic field is generated by coils, and a power receiver receives induced current and charges a battery depending on an electromagnetic induction phenomenon. Here, a part where the electromagnetic field is generated is referred to as a transceiver and a part that receives the induced current is referred to as a receiver.

In relation to this technology, Korean Patent No. 1581934 discloses technology of a multilayer coil assembly. However, the above coil assembly for wireless charging has a disadvantage that it is difficult to connect the start points during spot welding, and it is difficult to implement chargers of various capacities due to lack of standardization.

### SUMMARY OF THE INVENTION

Therefore, the present invention has been made in view of the above problems, and it is an object of the present invention to provide a flat coil-type wireless charging module and power supply that are capable of being used as chargers and transformers of various capacities through a laminated multilayer configuration.

It is another object of the present invention to provide a flat coil-type wireless charging module and power supply that are easy to manufacture and install, are in laminated states of various shape to be easily applied depending on an installation purpose, are manufactured in a sheet form and laminated to facilitate compact manufacturing, and facilitate power connection work.

In accordance with an aspect of the present invention, the above and other objects can be accomplished by the provision of a flat coil-type wireless charging module comprising flat coils as structures configured such that one or more plastic sheets are laminated to be electrically connected, wherein each plastic sheet has a predetermined conductive pattern integrally formed thereon to form a magnetic circuit used for magnetic induction or resonance induction, the conductive pattern is formed in a spiral shape and electrodes formed at both ends thereof are provided to be exposed from one or both sides of an edge of each plastic sheet, the plastic sheets are configured such that, when one conductive pattern formed on one plastic sheet is connected to another conductive pattern of another plastic sheet under the plastic sheet through a plated through hole, the conductive pattern is electrically connected to the other electrode, each plastic sheet is integrally provided with the electrodes connected to both ends of the conductive pattern at the edge thereof, the one or more plastic sheets are mounted in plural in a cartridge, and the cartridge is provided with a port having connection electrodes formed in mounting holes configured such that the one or more plastic sheets are inserted thereinto.

In accordance with another aspect of the present invention, there is provided a flat coil-type wireless charging module comprising flat coils as structures configured such that one or more plastic sheets are laminated to be electrically connected, wherein each plastic sheet has a predetermined conductive pattern integrally formed thereon to form a magnetic circuit used for magnetic induction or resonance induction, the conductive pattern is formed in a spiral shape and electrodes formed at both ends thereof are provided to be exposed from one or both sides of an edge of each plastic sheet, the plastic sheet are configured such that, when one electrode is provided on each plastic sheet, the other electrode is provided on a ground sheet laminated on a lower surface of each plastic sheet, and the electrode formed on each plastic sheet is electrically connected to a ground protrusion of the ground sheet laminated on the lower surface of each plastic sheet through a plated through hole to be electrically connected to a ground electrode provided on the ground sheet.

Each plastic sheet may be integrally provided with the electrodes connected to both ends of the conductive pattern at the edge thereof, the one or more plastic sheets may be mounted in plural in a cartridge, and the cartridge may be provided with a port having connection electrodes formed in mounting holes configured such that the one or more plastic sheets are inserted thereinto.

Each plastic sheet may be provided with an insulating layer on one side of the conductive pattern.

In accordance with another aspect of the present invention, there is provided a flat coil-type power supply including an assembly structure of flat coils configured such that core spaces are formed inside conductive patterns of the flat coils, and cores respectively inserted into the core spaces from top and bottom, wherein when one or more flat coils are arranged close to each other in the horizontal direction or laminated in the vertical direction, one or more cores are assembled in a vertical or horizontal direction so that the flat coil-type power supply is used as a transformer, each flat coil comprises a laminated structure of one or more plastic sheets comprising a conductive pattern formed on an upper surface of an insulating layer, the conductive pattern is formed in a C shape or spiral shape with a predetermined width, and electrodes are connected to both ends thereof, respectively, a cartridge configured such that the electrodes of the one or more plastic sheets are inserted thereinto is further provided, and the cartridge is provided with a port having connection electrodes formed in mounting holes configured such that the one or more plastic sheets are inserted thereinto.

The flat coils including the one or more plastic sheets may be provided integrally in plural on one substrate, and the flat coils may be installed so as to be separated from each other along cutting lines provided on the substrate.

The flat coils may be installed so that, if the flat coils are laminated in the vertical direction, when one electrode formed on one plastic sheet is connected to the conductive pattern of another plastic sheet under the plastic sheet through the conductive pattern and a plated through hole of the plastic sheet, the electrode is electrically connected to the other electrode.

When the cores inserted into the core spaces are arranged close to each other in a horizontal direction, a plurality of flat coils spaced apart from each of other in the horizontal direction may be connected to each other by other flat coils located thereunder and configured to overlap the plurality of plastic sheets on both sides.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating the appearance of a flat coil-type wireless charging module according to the present invention;

FIG. 2 is view illustrating the laminated state of the flat coil-type wireless charging module according to the present invention;

FIG. 3 is a view illustrating the manufacturing state of the flat coil-type wireless charging module according to the present invention;

FIG. 4 is a side view illustrating a flat coil-type wireless charging module according to another embodiment of the present invention;

FIG. 5 is a view illustrating the assembly state of flat coils for a transformer according to yet another embodiment of the present invention;

FIGS. 6 and 7 are views illustrating the assembly state of flat coils for a transformer according to other embodiments; FIGS. 8 and 9 are views illustrating the application state of coil-type and C-type substrates for manufacturing flat coils according to one embodiment of the present invention; and

FIG. 10 is a view illustrating the usage state of a flat coil-type power supply according to another embodiment of the present invention.

### DETAILED DESCRIPTION OF THE INVENTION

Hereinafter, the embodiments of the present invention will be described in detail based on the accompanying drawings.

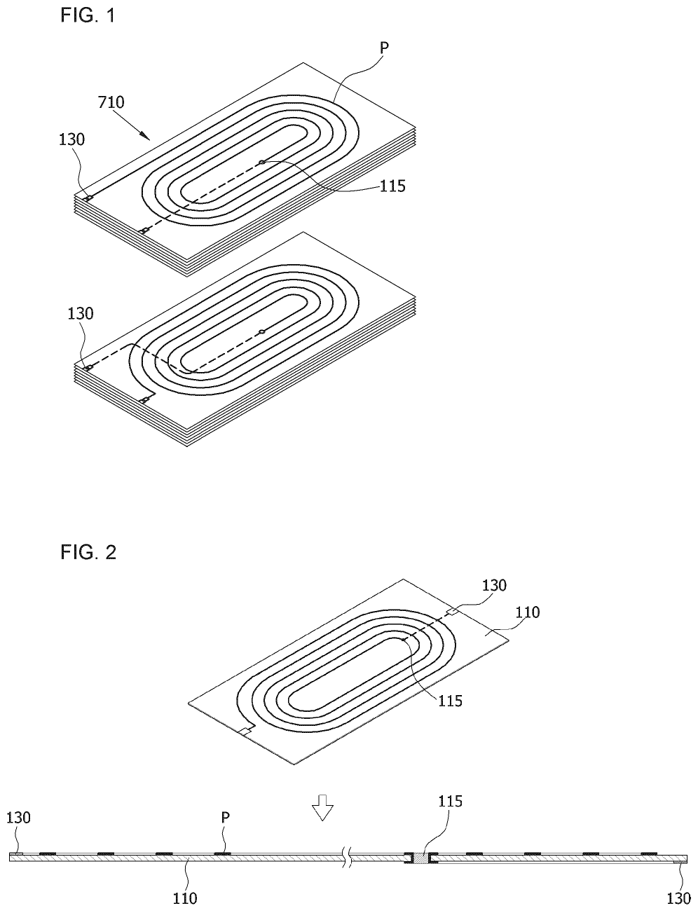

As illustrated in FIGS. 1 to 4, a flat coil 710 used for a wireless charger according to the present invention is configured such that one or more plastic sheets 110 having a predetermined conductive pattern P for forming a magnetic circuit used for magnetic induction or resonance induction are laminated.

That is, the flat coil 710 is formed as a single layer of the plastic sheet 110 or as a multilayer structure by laminating a plurality of plastic sheets 10.

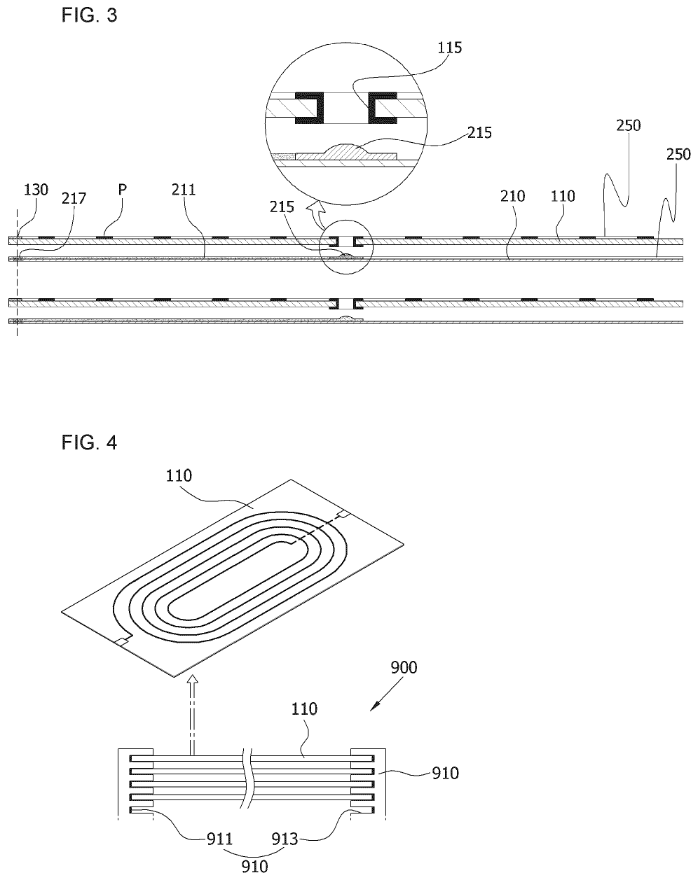

Here, as shown in FIG. 2, the conductive pattern P formed on each of the plastic sheets 110 is provided on the upper or lower surface of the plastic sheet 110, and each conductive pattern P formed on the upper or lower surface of the plastic sheet 110 is electrically connected to the other surface thereof through a Plated Through Hole (PTH) 115.

In addition, the conductive pattern P may be electrically connected to a plurality of electrodes 130 installed on one side or both sides of the plastic sheet 110 to be separated from each other.

The conductive pattern P formed on at least one of the upper or lower surface of the plastic sheet 110 is formed of a copper thin film layer.

Here, the conductive pattern P is provided on the plastic sheet 110 by any one selected from a method of bonding a copper thin film layer to the upper surface of the plastic sheet 110 with an adhesive, a method of forming a copper thin film layer by casting, and a method of forming a copper thin film layer by sputtering.

In addition, the plastic sheet 110 is selected from a polyimide film or a polyester film.

In addition, the conductive pattern P is disposed in a circular or arc shape so as to make predetermined turns from the outer diameter to the inner diameter thereof, and is disposed to have a predetermined thickness in the vertical direction.

Further, the electrodes 130 are provided to be in close contact with each other so as to be electrically connected to the conductive pattern P provided on each plastic sheet 110, when the plastic sheets 110 are laminated in the vertical direction.

When the plastic sheets 110 are laminated in the vertical direction, the respective patterns P may be connected in parallel in the horizontal direction, or be connected in the vertical direction.

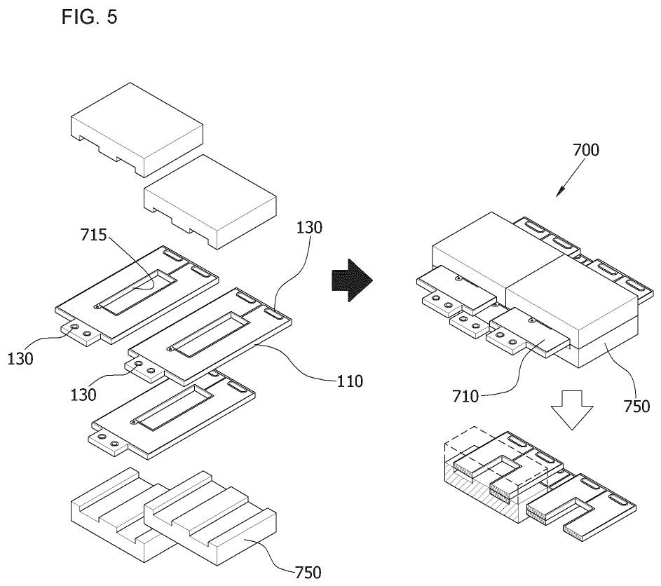

As shown in FIG. 3, the electrode 130 connected to the conductive pattern P may be provided to connect a circuit through a ground sheet 210 that is laminated on the lower surface of the plastic sheet 110 and has a separate ground pattern 211 exposed from the upper surface thereof to be connected to the Plated Through Hole (PTH) 115.

Here, the ground sheet 210 is provided with a ground protrusion 216 configured to be connected to the Plated Through Hole (PTH) 115 by pressing.

That is, the laminated structure of the plastic sheet 110 and the ground sheet 210 prepared as one set is electrically connected to the outside.

Further, the ground pattern 211 or the conductive pattern P may further be provided with an insulating layer 250 that spaces portions of the pattern 211 or P apart from each other along the inner or outer side thereof.

In addition, the ground pattern 211 is also provided with a ground electrode 217 configured such that the electrode 130 of the plastic sheet 110 is grounded thereto.

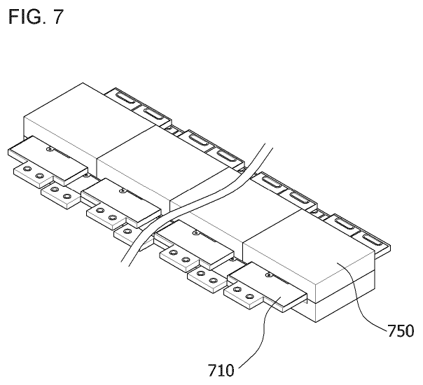

On the other hand, as shown in FIG. 5, the plastic sheets 110 may be mounted in a cartridge 900 configured to have at least one port 910 having connection electrodes 911 to be connected to the conductive patterns P so as to facilitate connection to an external power supply.

That is, the cartridge 900 is provided with mounting holes 913 into which the respective plastic sheets 110 are inserted, and the connection electrodes 911 to which the electrodes 130 are grounded are integrally formed in the mounting holes 913.

The operation of the present invention having the above configuration will be described.

As shown in FIGS. 1 to 4, a wireless charging module 100 of the present invention is configured such that the plurality of plastic sheets 110 having the predetermined conductive pattern P for forming a magnetic circuit used for magnetic induction or resonance induction is laminated in multiple layers, so that the number of turns or a surface area may be implemented to achieve a desired overall capacity.

Further, when the plastic sheets 110 are laminated in multiple layers, the conductive patterns P respectively formed on the plastic sheets 110 are electrically connected through the Plated Through Holes (PTHs) 115, thereby being capable of implementing the number of turns or the surface area to achieve the desired overall capacity.

That is, the conductive patterns P on the respective plastic sheets 110 are connected to each other in the vertical direction so as to have a spiral shape overall while having a predetermined surface area.

In addition, the conductive patterns P on the respective plastic sheets 110 are electrically connected through the respective electrodes 130 connected to the conductive patterns P, so that when the respective conductive patterns P are connected in parallel or in series, a desired surface area or the desired number of turns may be implemented.

Further, the conductive pattern P is provided on at least one of the upper or lower surface of each of the plastic sheets 110 by any one selected from a method of bonding a copper thin film layer to the upper surface of the plastic sheet 110 with an adhesive, a method of forming a copper thin film layer by casting, and a method of forming a copper thin film layer by sputtering, thereby being easily manufactured.

In addition, the plastic sheet 110 is selected from a polyimide film or a polyester film to provide a predetermined insulating layer when the conductive pattern P is formed thereon.

Here, the conductive pattern P or the ground pattern 211 is further provided with the insulating layer 250 that has the same thickness as the pattern P or 211 and spaces or insulates portions of the pattern P or 211 apart from each other along the inner or outer side thereof, and the conductive pattern P or the ground pattern 211 and the insulating layer 250 form the same surface, thereby forming the same thickness overall.

As shown in FIG. 3, the electrode pattern 130 connected to the conductive pattern P is connected to the ground electrode 217 formed on the ground sheet 210 laminated on the lower surface of the plastic sheet 110 by connecting the conductive pattern P of the plastic sheet 210 to the ground pattern 211 of the ground sheet 210 by pressing so that the ground protrusion 215 of the ground sheet 210 is inserted into through the Plated Through Hole (PTH) 115, thereby enabling power supply.

Here, the ground sheet 210 is provided with the ground protrusion 215 corresponding to the Plated Through Hole (PTH) 115 for pressing connection, thereby enabling electrical connection.

That is, when the ground sheet 210 is laminated on the lower surface of the plastic sheet 110, the conductive patterns P provided on the upper and lower plastic sheets 110 are electrically connected.

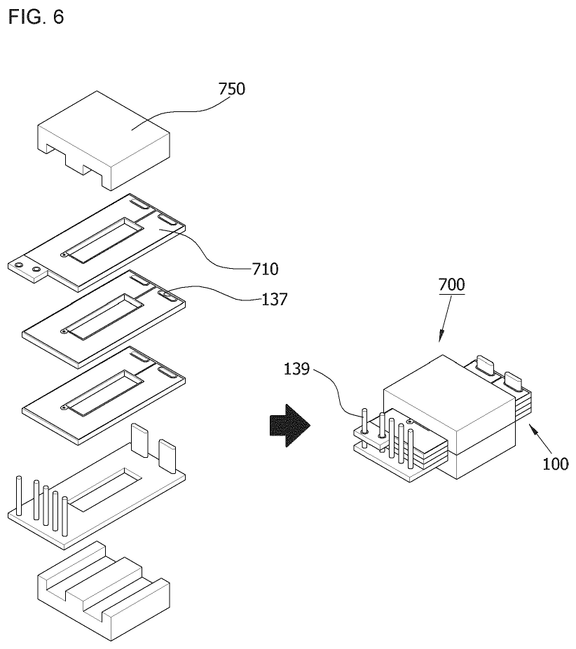

In addition, as shown in FIG. 4, the plastic sheets 110 are provided in at least one port 910 connected to the conductive patterns P so as to facilitate connection to an external power supply, so that, when the conductive patterns P laminated in multiple layers are electrically connected to each other, power input and output from and to the outside are possible.

Here, the plastic sheets 110 are mounted in the cartridge 900 that is separately provided, so as to further facilitate connection to the external power supply.

That is, the cartridge 900 is provided with a plurality of mounting holes 913 into which the respective plastic sheets 110 are inserted, so that the plurality of plastic sheets 110 is supported by the respective mounting holes 913 and the conductive pattern P formed on each plastic sheet 110 is electrically connected to the connection electrodes 911 provided in the mounting holes 913.

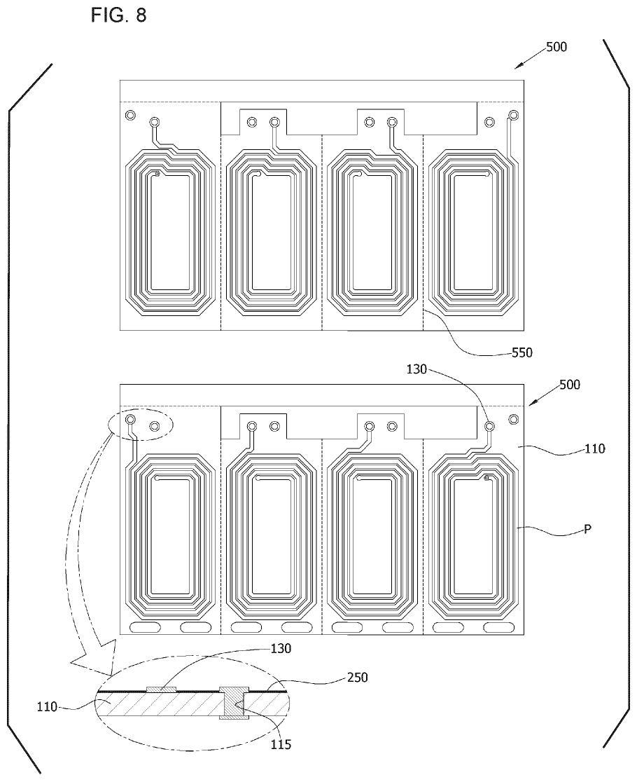

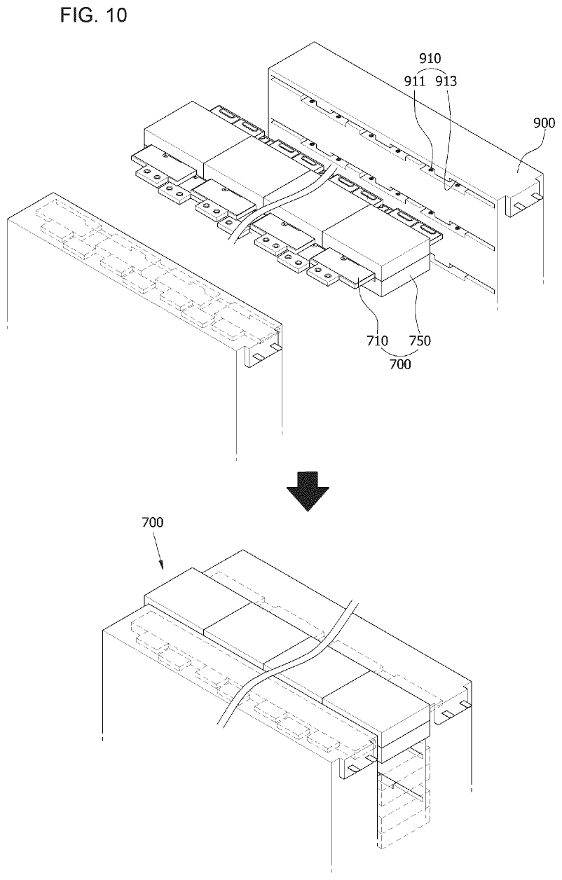

On the other hand, as shown in FIGS. 5 to 10, a power supply 700 used as a transformer according to the present invention uses flat coils 710 in which one or more plastic sheets 110 having the predetermined conductive pattern P formed on the upper surfaces thereof to form a magnetic circuit to which the principle of magnetic induction or resonance induction is applied are laminated.

In addition, the conductive pattern P extends in a C shape having a predetermined width or in a track shape extending inward or outward, and the electrode 130 is connected to each end thereof.

Further, a plurality of flat coils 710, each of which includes the plastic sheets 110, may be integrally provided on a single substrate 500 having a predetermined area.

Here, if the plurality of flat coils 710 is integrally provided on the single substrate 500, the flat coils 710 are manufactured to be separated from each other through cutting lines 550.

In addition, the flat coils 710 including the plastic sheets 110 are provided with a core space 715 formed therethrough to be located inside the conductive patterns P. Here, the core space 715 is formed by removing a separation piece 515 from the substrate 500 along the cutting lines 550.

Further, the conductive pattern P formed on each plastic sheet 110 is provided on the upper or lower surface of the plastic sheet 110 formed of a plastic material, and the respective conductive patterns P formed on the upper or lower surfaces of the plastic sheets 110 are electrically connected through the Plated Through Holes (PTH) 115.

In addition, the conductive pattern P is electrically connected to the electrodes 130 installed on one side surface or both side surfaces of the plastic sheet 110 to be separated from each other.

Further, the electrodes 130 are installed to be connected to each other so as to electrically connect the respective conductive patterns P to each other, when the plastic sheets 110 are laminated in the vertical direction.

The plastic sheets 110 are laminated in the vertical direction or connected to each other so as to be arranged in the horizontal direction.

Further, the conductive pattern P may further be provided with the insulating layer 250 that spaces the portions of the conductive pattern P apart from each other along the inner or outer side thereof.

In addition, the electrode 130 may be provided with a connection hole 137 formed therethrough, or be installed so that electrode pins 139 are inserted thereinto.

The power supply 700 of the present invention is installed so as to be used as a charger having a form in which a plurality of plastic sheets 110 is laminated or a transformer having a form in which a core 750 is connected to the flat coils 710 having a configuration in which one or more plastic sheets 110 are laminated.

Here, when used as a transformer, the power supply 700 is formed as the assembly structure of the flat coils 710 having the core space 715 and the core 750 inserted into the core space 715 from the top and bottom, respectively.

Further, in the power supply 700, when one or more flat coils 710 are arranged close to each other in the horizontal direction or laminated in the vertical direction, one or more cores 750 are assembled in the vertical or horizontal direction.

In addition, the cartridge 900, which electrically connects the plurality of plastic sheets 110 to each other when the electrodes 130 of the flat coils 710 are inserted into the cartridge 900, is further connected to the power supply 700.

At this time, the cartridge 900 is installed so that the plurality of flat coils 710 is mounted therein depending on a capacity achieved by the port 910 provided with a plurality of mount holes 913 configured such that the electrodes 130 of the flat coils 710 including the plastic sheets 110 are inserted thereinto and the connection electrodes 911 corresponding to the electrodes 130.

Further, the flat coil 710 is installed so that, if the plastic sheets 110 are laminated in the vertical direction, when one electrode 130 formed on one plastic sheet 110 is connected to the conductive pattern P of another plastic sheet 110 under the plastic sheet 110 through the conductive pattern P and the PTH 115 of the plastic sheet 110, the electrode 130 is connected to the other electrode 130 of the other plastic sheet 110.

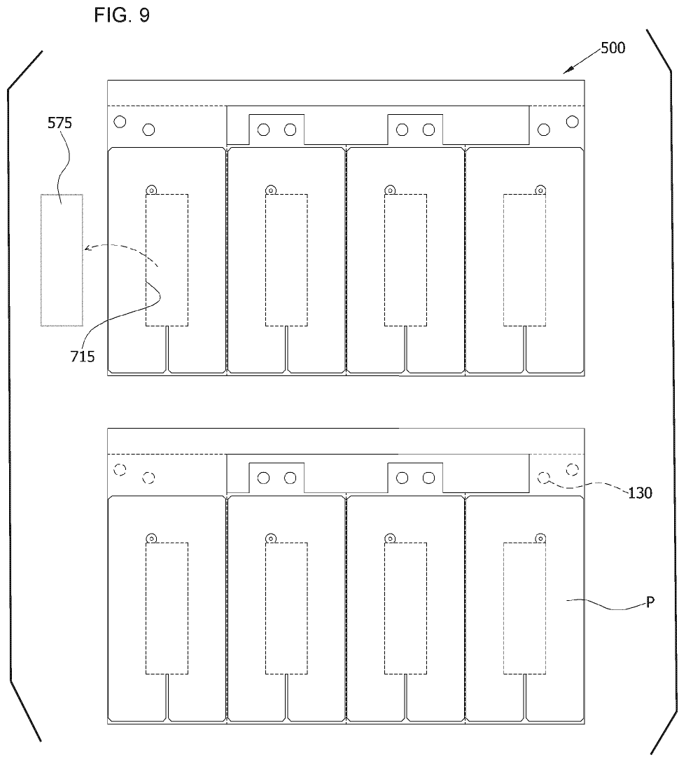

Furthermore, as shown in FIG. 7, the flat coils 710 are installed so that, when the cores 750, each of which is inserted into the core space 715, are arranged close to each other in the horizontal direction, a plurality of plastic sheets 110 spaced apart from each other in the horizonal direction is connected to each other by plastic sheets 110 that are located thereunder and overlap the plurality of plastic sheets 110 on both sides.

The operation of the present invention having the above configuration will be described.

As shown in FIGS. 5 to 10, the power supply 700 of the present invention includes the flat coils 710 configured such that the plurality of plastic sheets 110 having the predetermined conductive pattern P for forming a magnetic circuit used for magnetic induction or resonance induction is laminated in multiple layers, so that the number of turns or a surface area may be implemented to achieve a desired overall capacity.

Further, when the plastic sheets 110 configured to form the flat coil 710 are laminated in multiple layers, one end of the conductive pattern P formed on each plastic sheet 110 is connected to the electrode 130 through the PTH 115, and thus, when the plastic sheets 110 are laminated, the conductive patterns P are electrically connected to each electrode 130, thereby being capable of implementing the number of turns or the surface area to achieve the desired overall capacity.

That is, the conductive patterns P of the present invention are connected to each other in the vertical direction so as to have an overall spiral shape while having a predetermined surface area, when laminated in the vertical direction.

In addition, the conductive patterns P on the respective plastic sheets 110 are electrically connected through the respective electrodes 130 connected to the conductive patterns P, so that, when the respective conductive patterns P are connected in parallel or in series, a desired surface area or the desired number of turns may be implemented.

Further, the conductive pattern P is provided on at least one of the upper or lower surface of the plastic sheet 110 by any one selected from a method of bonding a copper thin film layer to the upper surface of the plastic sheet 110 with an adhesive, a method of forming a copper thin film layer by casting, and a method of forming a copper thin film layer by sputtering, thereby being easily manufactured.

In addition, the plastic sheet 110 is formed of polyimide or polyester to have a predetermined thickness or selected from a polyimide film or a polyester film, thereby providing a predetermined insulating layer when the conductive pattern P is formed thereon.

In addition, the plastic sheets 110 are provided in at least one port 910 connected to the conductive patterns P so as to facilitate connection to an external power supply, so that, when the conductive patterns P laminated in multiple layers are electrically connected to each other, power input and output from and to the outside are facilitated.

Here, the plastic sheets 110 are mounted in the cartridge 900 separately provided with the port 910, so as to further facilitate connection to the external power supply.

That is, the cartridge 900 is provided with a plurality of mounting holes 913 into which the respective plastic sheets 110 are inserted, so that the plurality of plastic sheets 110 is supported by the respective mounting holes 913 and the conductive pattern P formed on each plastic sheet 110 is electrically connected to the connection electrodes 911 provided in the mounting holes 913.

In addition, the electrode 130 is provided with at least one connection hole 137 formed therethrough, and enables the respective flat coils 710 laminated at determined positions to be easily connected to each other when the electrode pins 139 connected to at least one flat coil 710 are inserted into the connecting hole 137.

The power supply 700 of the present invention is used as a charger having a form in which a plurality of plastic sheets 110 is laminated or a transformer having a form in which the core 750 is connected to the flat coils 710 having a configuration in which one or more plastic sheets 110 are laminated.

Here, when used as a transformer, the power supply 700 is formed as the assembly structure of the flat coils 710 having the core space 715 and the core 750 inserted into the core space 715 from the top and bottom, so that it is possible to manufacture a transformer having a desired capacity when the plurality of flat coils 710 is laminated.

Further, when one or more flat coils 710 are arranged close to each other in the horizontal direction or laminated in the vertical direction, the power supply 700 enables one or more cores 750 to be assembled in the vertical or horizontal direction, so that the plurality of flat coils 710 is connected to implement a desired capacity.

In addition, the power supply 700 is mounted in the cartridge 900 installed to electrically connect the plurality of plastic sheets 110 to each other when the electrodes 130 of the flat coils 710 are inserted into the cartridge 900, thereby facilitating supply and transmission of power when the electrodes 130 of the flat coils 710 are grounded to the connection electrodes 911 of the mounting holes 913 formed in the port 910 of the cartridge 900.

Here, the cartridge 900 is installed so that the respective connection electrodes 911 are electrically connected to each other, and may implement a desired capacity depending on the number of the flat coils 710 mounted in the cartridge 900.

Furthermore, as shown in FIG. 7, the flat coils 710 are installed so that, when the cores 750, each of which is inserted into the core space 715, are arranged close to each other in the horizontal direction, a plurality of plastic sheets 110 spaced apart from each other in the horizonal direction is connected to each other by plastic sheets 110 that are located thereunder and overlap the plurality of plastic sheet 110 on both sides, thereby facilitating connection of the plurality of flat coils 710 in the horizontal direction.

As is apparent from the above description, a flat coil- type wireless charging module and power supply according to the present invention may be used as a charging module and a transformer having various capacities through a laminated multilayer configuration.

In addition, the flat coil-type wireless charging module and power supply according to the present invention may be easily manufactured and installed through a configuration in which flat coils are separated and assembled depending on a capacity after mass production.

In addition, the flat coil-type wireless charging module and power supply according to the present invention may be easily applied depending on an installation area due to the laminated state thereof provided in various shapes.

In addition, the flat coil-type wireless charging module and power supply according to the present invention may be easily manufactured with a compact structure by laminating and bonding sheets, and enable the respective sheets to be electrically connected when laminated, thereby facilitating power connection work.

It is apparent that various modifications are possible within the scope of the present invention.

Therefore, the scope of the present invention should not be limited to the above-described embodiments, but should be determined by the scope of the appended claims as well as the equivalents to the scope of the claims.

As described above, although the present invention has been described through the embodiments and drawings, the present invention is not limited to the above embodiments, and various modifications and variations are possible from the above description by those skilled in the art to which the present invention pertains.

Therefore, the spirit of the present invention should be understood only by the scope of the appended claims described below, and all equivalents or modifications thereof within the scope of the spirit of the present invention are to be construed as being included in the present invention.

What is claimed is:

1. A flat coil-type wireless charging module comprising flat coils as structures configured such that one or more plastic sheets are laminated to be electrically connected, wherein:
each plastic sheet has a predetermined conductive pattern integrally formed thereon to form a magnetic circuit used for magnetic induction or resonance induction;
the conductive pattern is formed in a spiral shape and electrodes formed at both ends thereof are provided to be exposed from one or both sides of an edge of each plastic sheet;
the plastic sheets are configured such that, when one conductive pattern formed on one plastic sheet is connected to another conductive pattern of another plastic sheet under the plastic sheet through a plated through hole, the conductive pattern is electrically connected to the other electrode;
each plastic sheet is integrally provided with the electrodes connected to both ends of the conductive pattern at the edge thereof;
the one or more plastic sheets are mounted in plural in a cartridge; and
the cartridge is provided with a port having connection electrodes formed in mounting holes configured such that the one or more plastic sheets are inserted thereinto.

2. A flat coil-type wireless charging module comprising flat coils as structures configured such that one or more plastic sheets are laminated to be electrically connected, wherein:
each plastic sheet has a predetermined conductive pattern integrally formed thereon to form a magnetic circuit used for magnetic induction or resonance induction;
the conductive pattern is formed in a spiral shape and electrodes formed at both ends thereof are provided to be exposed from one or both sides of an edge of each plastic sheet;
the plastic sheets are configured such that, when one electrode is provided on each plastic sheet, the other electrode is provided on a ground sheet laminated on a lower surface of each plastic sheet; and
the electrode formed on each plastic sheet is electrically connected to a ground protrusion of the ground sheet laminated on the lower surface of each plastic sheet through a plated through hole to be electrically connected to a ground electrode provided on the ground sheet.

3. The flat coil-type wireless charging module according to claim 2, wherein:
each plastic sheet is integrally provided with the electrodes connected to both ends of the conductive pattern at the edge thereof;
the one or more plastic sheets are mounted in plural in a cartridge; and
the cartridge is provided with a port having connection electrodes formed in mounting holes configured such that the one or more plastic sheets are inserted thereinto.

4. A flat coil-type power supply comprising:
an assembly structure of flat coils configured such that core spaces are formed inside conductive patterns of the flat coils, and cores respectively inserted into the core spaces from top and bottom, wherein:
when one or more flat coils are arranged close to each other in a horizontal direction or laminated in a vertical direction, one or more cores are assembled in the vertical or horizontal direction so that the flat coil-type power supply is used as a transformer;
each flat coil comprises a laminated structure of one or more plastic sheets comprising a conductive pattern formed on an upper surface of an insulating layer;
the conductive pattern is formed in a C shape or spiral shape with a predetermined width, and electrodes are connected to both ends thereof, respectively;
a cartridge configured such that the electrodes of the one or more plastic sheets of the flat coils are inserted thereinto is further provided; and
the cartridge is provided with a port having connection electrodes formed in mounting holes configured such that the one or more plastic sheets are inserted thereinto.

5. The flat coil-type power supply according to claim 4, wherein:
the flat coils comprising the one or more plastic sheets are provided integrally in plural on one substrate; and
the flat coils are installed so as to be separated from each other along cutting lines provided on the substrate.

6. The flat coil-type power supply according to claim 4, wherein the flat coils are installed so that, if the flat coils are laminated in the vertical direction, when one electrode formed on one plastic sheet is connected to another conductive pattern of another plastic sheet under the plastic sheet through the conductive pattern and a plated through hole of the plastic sheet, the electrode is electrically connected to the other electrode.

7. The flat coil-type power supply according to claim 4, wherein, when the cores inserted into the core spaces are arranged close to each other in the horizontal direction, a plurality of flat coils spaced apart from each other in the horizontal direction is connected to each other by other flat coils located thereunder and configured to overlap the plurality of plastic sheets on both sides.
